(19) United States
(12) Patent Application Publication
(10) Pub. No.: US 2024/0311983 A1
(43) Pub. Date: Sep. 19, 2024

(54) SYSTEM AND METHOD FOR CORRECTING DISTORTED IMAGES

(71) Applicant: Verizon Patent and Licensing Inc., Basking Ridge, NJ (US)

(72) Inventors: Subham Biswas, Maharashtra (IN); Saurabh Tahiliani, Uttar Pradesh (IN)

(21) Appl. No.: 18/122,159

(22) Filed: Mar. 16, 2023

(51) Int. Cl. G06T 5/00; G06T 5/50; G06V 10/774; G06V 10/82; G06V 20/40

(52) U.S. Cl. CPC G06T 5/77; G06T 5/50; G06T 5/80; G06V 10/774; G06V 10/82; G06V 20/40; G06T 2207/10016; G06T 2207/20081; G06T 2207/20084

(57) ABSTRACT

In an example, an image may be identified. Object detection may be performed on the image to identify a region including a distorted representation of an object. The region may be masked to generate a masked image including a masked region corresponding to the object. Using a machine learning model, the masked region may be replaced with an undistorted representation of the object to generate a modified image.

### BACKGROUND

Many platforms exist that allow users to share content including images, videos, etc. However, some images and/or videos may be visually distorted. For example, straight lines in an image appear to be curved or deformed. Such visual distortions may be associated with a lower image quality, and may provide for a negative user experience of users viewing the distorted images and/or videos.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating an example scenario in which a first client device provides a video stream to an example system for distortion correction according to some embodiments.

FIG. 1B is a diagram illustrating an example system for correcting distortions in a video stream, where a region of interest of a first video frame is identified according to some embodiments.

FIG. 1C is a diagram illustrating an example of a video frame and a region of interest of the video frame according to some embodiments.

FIG. 1D is a diagram illustrating an example system for correcting distortions in a video stream, where an object detection module performs object detection on a region of interest to identify one or more objects according to some embodiments.

FIG. 1E is a diagram illustrating an example system for correcting distortions in a video stream, where a first machine learning model is used to generate a modified image according to some embodiments.

FIG. 2 is a flow chart illustrating an example method for correcting distortions in a video stream, according to some embodiments.

FIG. 3A is a diagram illustrating an example system for training a first machine learning model, where the first machine learning model is used to replace a masked region of a masked image with a representation of an object to generate an output image according to some embodiments

FIG. 3B is a diagram illustrating an example system for training a first machine learning model, where a second machine learning model is used to generate a fault flag representation based upon an output image provided by the first machine learning model according to some embodiments

FIG. 4 is a flow chart illustrating an example method for correcting distortions in an image, according to some embodiments.

FIG. 5 is an illustration of a scenario involving various examples of transmission mediums that may be used to communicatively couple computers and clients.

FIG. 6 is an illustration of a scenario involving an example configuration of a computer that may utilize and/or implement at least a portion of the techniques presented herein.

FIG. 7 is an illustration of a scenario involving an example configuration of a client that may utilize and/or implement at least a portion of the techniques presented herein.

FIG. 8 is an illustration of a scenario featuring an example non-transitory machine-readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques for correcting distortions in video streams and/or images are provided. In accordance with one or more of the techniques provided herein, a video stream correction system is provided, which may correct at least some distortions in a first video stream to generate a second video stream (corresponding to a corrected version of the first video stream, for example). In some examples, the first video stream may be captured with a camera that has a wide or ultrawide field of view, which may introduce one or more distortions (e.g., at least one of fish-eye lens distortion, barrel distortion, etc.) to the first video stream. Using the techniques provided herein, the one or more distortions may be corrected using a machine learning model (e.g., a trained machine learning model) that may predict pixel values in a contextually aware and/or dynamic manner. As compared to some systems that correct distortions merely using a (static) rule-based approach and/or using a known object's dimensions as a reference point (e.g., scaling sections of a video frame using a scaling factor calculated based upon a known length of an object and a distorted length of the object), using the machine learning model according to the techniques provided herein may result in dynamically correcting distortions of the first video stream with increased accuracy.

In accordance with some embodiments of the present disclosure, the second video stream may be shown to one or more participants a video call (e.g., a conference call, a virtual reality communication session, etc.). In an example, the second video stream may comprise a desktop view of a desk (to provide the one or more participants with an additional perspective, for example). The techniques of the present disclosure may be used to replace distorted representations of objects on the desktop with undistorted (e.g., corrected) representations of the objects (e.g., the undistorted representations of the objects may be included in the second video stream). The systems that correct distortions using the rule-based approach may not be able to correct at least some of the distorted representations of the objects. For example, the rule-based approach may not be used to accurately correct a distorted representation of an object with a height that exceeds a threshold height, whereas using the techniques provided herein, the distorted representation of the object (with the height exceeding the threshold height) may be accurately corrected (e.g., the distorted representation may be replaced with an undistorted representation of the object) using the machine learning model in accordance with the techniques provided herein.

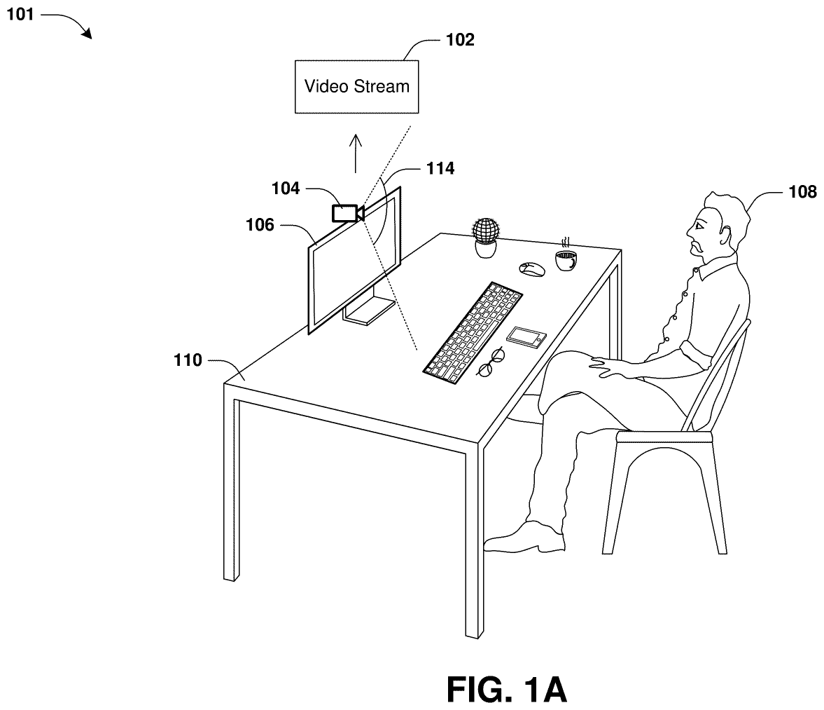

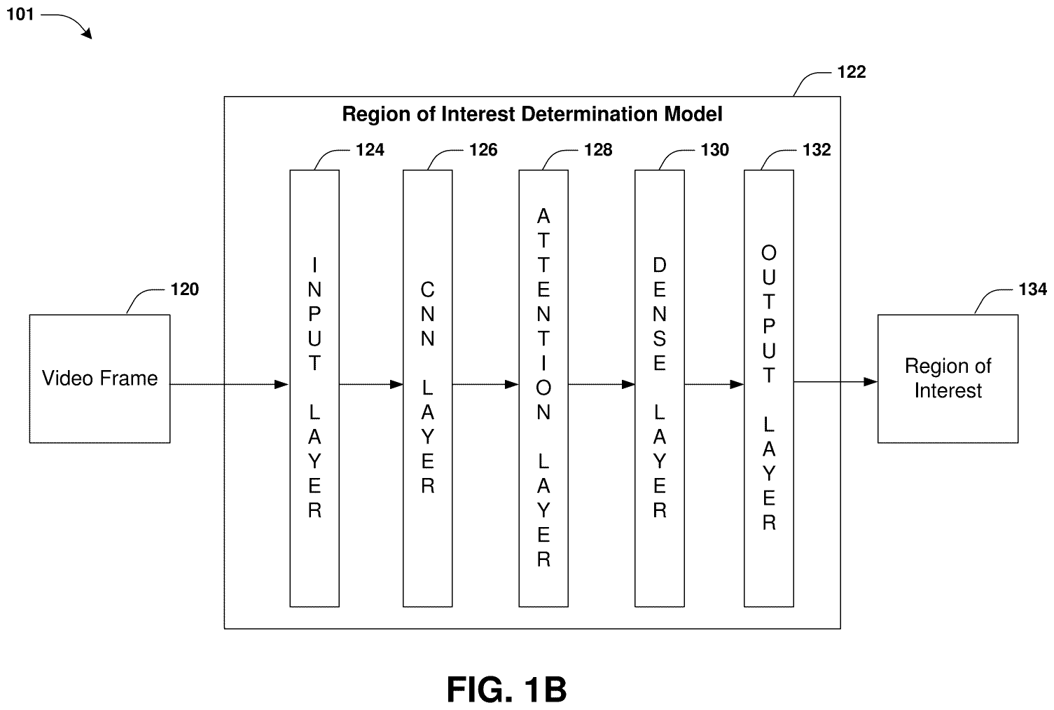

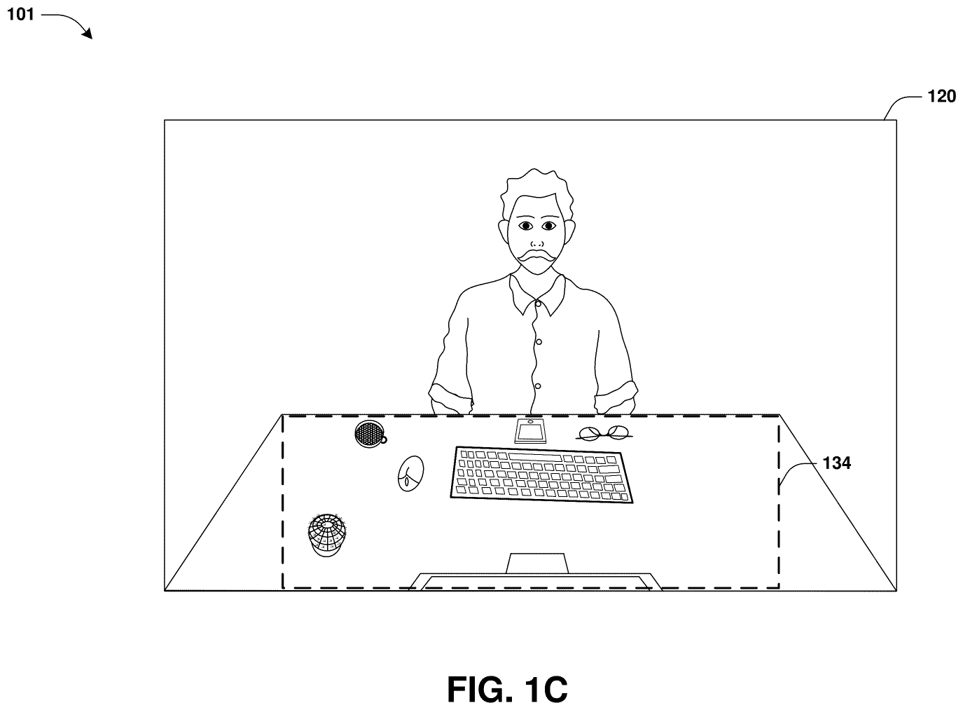

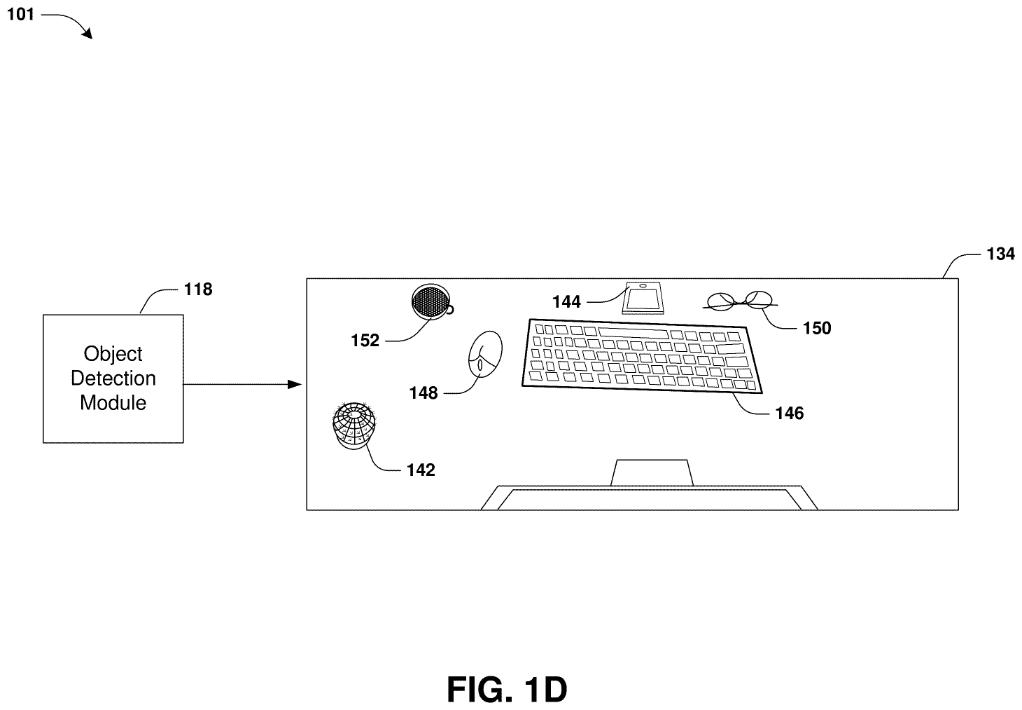

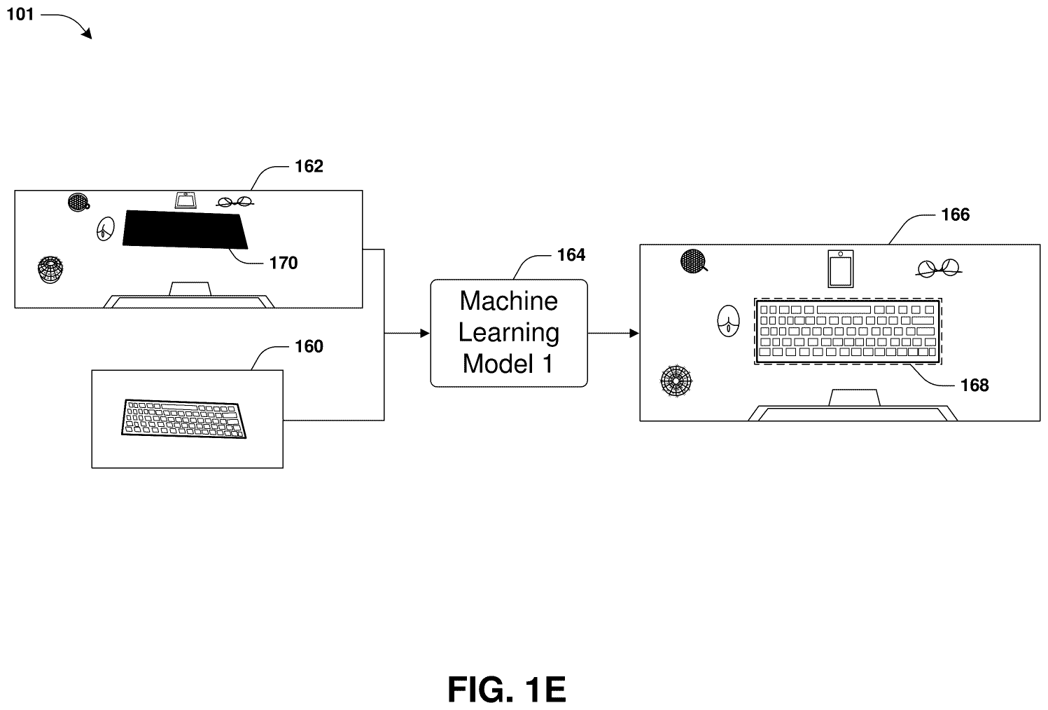

FIGS. 1A-1E illustrate examples of a system 101 for correcting distortions in a video stream. FIG. 1A illustrates a first client device 106 (e.g., a laptop, a smartphone, a tablet, a wearable device, etc.) associated with a user 108 providing a first video stream 102. The first video stream 102 may be provided to the system 101 (e.g., the first video stream 102 may be transmitted to a server of the system 101). In some examples, the first video stream 102 may comprise a real-time representation of a view of a first camera 104 associated with the first client device 106. In an example, the first camera 104 may be a camera that is mounted on and/or embedded in the first client device 106. Alternatively and/or additionally, the first camera 104 may be a standalone camera (e.g., the first camera 104 may be a security camera and/or a different type of camera, such as a webcam and/or an external camera, that may or may not be mounted on the first client device 106). The first camera 104 may be connected to the first client device 106 via a wired or wireless connection.

In some examples, the first video stream 102 may be sent by the first client device 106 in association with a video call established between the first client device 106 and a second client device (not shown). In an example, a communication system may establish the video call in response to receiving a request to establish the video call from the first client device 106 and/or the second client device. In an example, the first client device 106 may correspond to a caller and/or originator of the video call and the second client device may correspond to a receiver and/or destination of the video call, or vice versa. When the video call is established, a video corresponding to the first video stream 102 (captured using the first camera 104) may be displayed on the second client device (such that a user of the second client device is able to see the video while conversing with the user 108 over the video call, for example). Other users and/or client devices (in addition to the first client device 106 and/or the second client device, for example) may be participants of the video call. In some examples, the video call may be implemented in a virtual reality environment (e.g., a metaverse).

In some examples, an angle 114 of a field of view associated with the first camera 104 and/or the first video stream 102 may be at least a threshold angle associate with a wide or ultrawide field of view. In an example, the first camera 104 may correspond to a wide or ultrawide camera associated with the wide or ultrawide field of view (e.g., the first camera 104 may capture a wider field of view relative to some cameras). The threshold angle may be 90 degrees, 100 degrees, 110 degrees, 120 degrees, or other value. In an example in which the first client device 106 and/or the first camera 104 is on and/or over a desktop of a desk 110, the field of view (e.g., the wide or ultrawide field of view) associated with the first camera 104 may encompass (i) at least a portion of the desktop of the desk 110 and/or (ii) a face of the user 108 of the first client device 106. Accordingly, the first video stream 102 captured by the first camera 104 may show (i) at least a portion of the desktop of the desk 110 and/or (ii) the face of the user 108. However, the first video stream 102 may comprise one or more distortions (e.g., fish-eye lens distortion, barrel distortion, and/or one or more other distortions that may be found in images captured using the wide or ultrawide field of view). Using the techniques provided herein, a video stream correction system (e.g., the system 101) may correct at least some distortions in the first video stream 102, and/or may provide a corrected version of the first video stream 102 for display on the second client device.

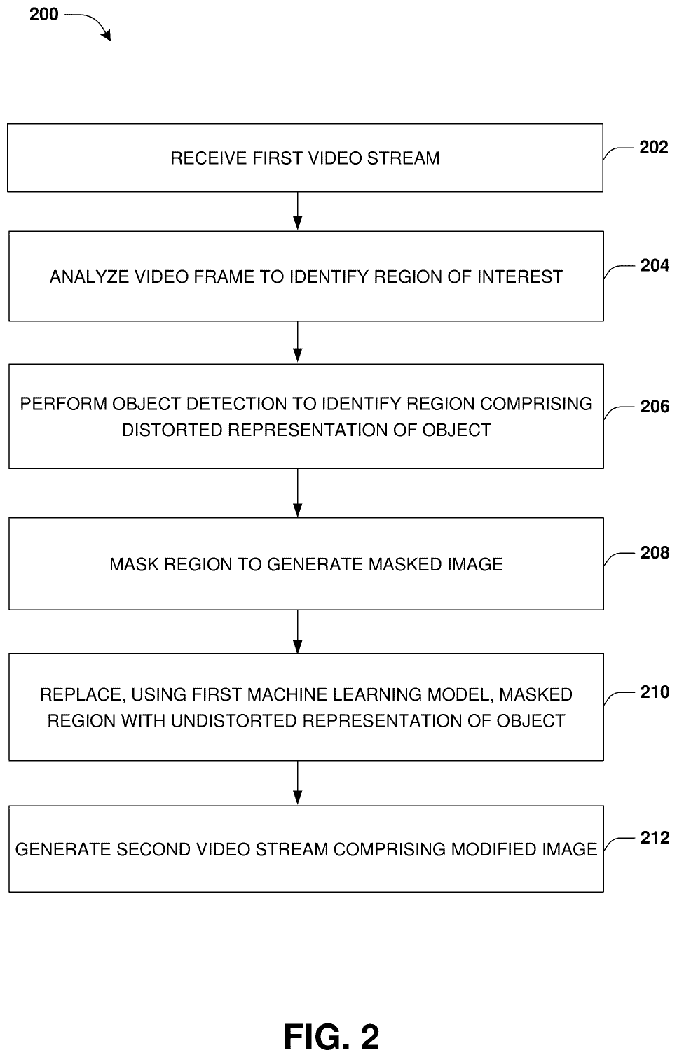

An embodiment of correcting distortions in a video stream is illustrated by an exemplary method 200 of FIG. 2, and is further described in conjunction with the system 101 of FIGS. 1A-1E. At 202, the video stream correction system may receive the first video stream 102. At 204, the video stream correction system may analyze a first video frame of the first video stream 102 to identify a region of interest of the first video frame. In an example, the region of interest may correspond to a region targeted by the video stream correction system for distortion correction (e.g., the video stream correction system may focus on detecting and/or correcting distorted objects in the region of interest).

FIG. 1B illustrates an exemplary method for determination of the region of interest (shown with reference number 134). In an example, the region of interest 134 may be determined using a region of interest determination model 122. The first video frame (shown with reference number 120) may be input to the region of interest determination model 122, which may analyze the first video frame 120 to determine boundaries of the region of interest 134. The region of interest determination model 122 may comprise a convolutional context-aware model. The region of interest determination model 122 may comprise a plurality of layers. In an example, each layer of one, some and/or all layers of the plurality of layers may be a dense layer, such as a fully connected dense layer. In some examples, an activation function of the region of interest determination model 122 may comprise a rectified linear unit. In some examples, a loss function of the region of interest determination model 122 may comprise Mean Absolute Error (MAE) and/or Mean Squared Error (MSE). In an example, the plurality of layers comprises a first layer 124 (e.g., an input layer), a second layer 126 (e.g., a convolutional neural network (CNN) layer connected to the input layer), a third layer 128 (e.g., an attention layer connected to the CNN layer), a fourth layer 130 (e.g., a dense layer connected to the attention layer), and/or a fifth layer 132 (e.g., an output layer connected to the dense layer), wherein the region of interest 134 may be output by the fifth layer 132. FIG. 1C illustrates an example of the first video frame 120 and the region of interest 134 of the first video frame 120. The region of interest 134 may comprise a representation of the desktop of the desk 110.

Returning back to the flow diagram of FIG. 2, at 206 the video stream correction system may perform object detection on the region of interest 134 of the first video frame 120 to identify a first region (in the region of interest 134, for example) comprising a distorted representation of a first object. In an example shown in FIG. 1D, an object detection module 118 may perform object detection on the region of interest 134 to identify objects comprising at least one of a desk plant 142, a phone 144, a keyboard 146, a mouse 148, eye-glasses 150, a mug 152, etc. At least some of the objects may be distorted in the first video frame 120 (e.g., the keyboard 146 is shown having an abnormal shape with angled sides different from an actual rectangular shape of the keyboard 146). In an example, the first object may correspond to the keyboard 146, and the first region may correspond to a region, of the first video frame 120, that is occupied by the keyboard 146. In some examples, the first region (occupied by the keyboard 146, for example) may be determined by performing object segmentation (e.g., instance segmentation) on the first object (e.g., the keyboard 146).

At 208 of FIG. 2, the video stream correction system may mask the first region to generate a first masked image comprising a masked region corresponding to the first object. For example, masking the first region may comprise setting some or all pixels of the first region to a predefined color (e.g., a predefined pixel value), such as at least one of white, black, etc. Accordingly, in some examples, the first masked image may comprise the masked region, having the predefined color, in place of the first object.

At 210 of FIG. 2, using a first machine learning model, the video stream correction system may replace the masked region with an undistorted representation of the first object to generate a modified image (e.g., a corrected image). For example, the modified image may be generated, using the first machine learning model, to comprise the undistorted representation of the first object in place of the masked region. In an example, the video stream correction system may regenerate, using the first machine learning model, pixels of the masked region of the first masked image to generate the modified image comprising the undistorted representation of the first object. In some examples, the modified image is generated (using the first machine learning model, for example) based upon the distorted representation of the first object.

FIG. 1E illustrates the first machine learning model (shown with reference number 164) being used to generate the modified image (shown with reference number 166). For example, the distorted representation (shown with reference number 160) of the first object and the first masked image (shown with reference number 162) comprising the masked region (shown with reference number 170) may be input to the first machine learning model 164, which may use the distorted representation 160 of the first object and the first masked image 162 to generate the modified image 166. For example, the first machine learning model 164 may be used to regenerate pixels of the masked region 170 of the first masked image 162 to generate the undistorted representation (shown with reference number 168) of the first object (e.g., the keyboard 146). In the example shown in FIG. 1E, the distorted representation 160 of the first object corresponds to a region, of the first video frame 120, comprising the keyboard 146. In some examples, the first machine learning model 164 may be trained to generate the undistorted representation 168 of the first object (e.g., the keyboard 146) in a contextually aware manner.

In some examples, the first machine learning model 164 is trained to predict, in a contextually aware manner, pixel values (e.g., colors) for pixels of a masked region of a masked image, wherein a first loss function of the first machine learning model 164 may be based upon (i) an original image (e.g., an image that is partially masked to generate the masked image) and/or (ii) a reference image (e.g., a reference image of an object, in the original image, that is masked to generate the masked image).

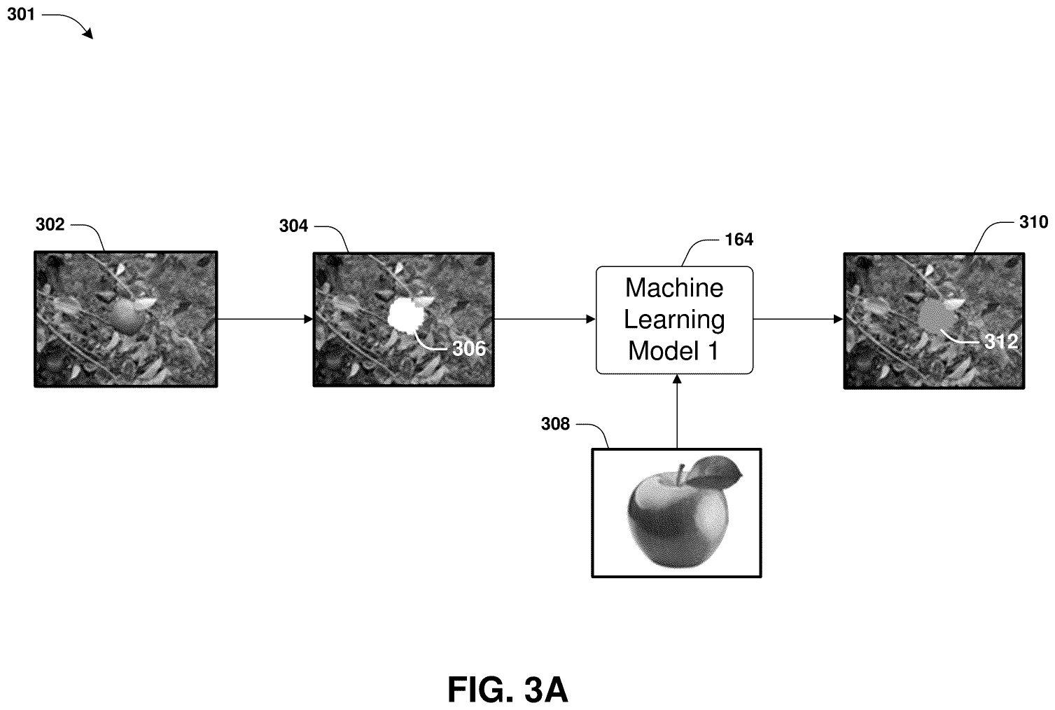

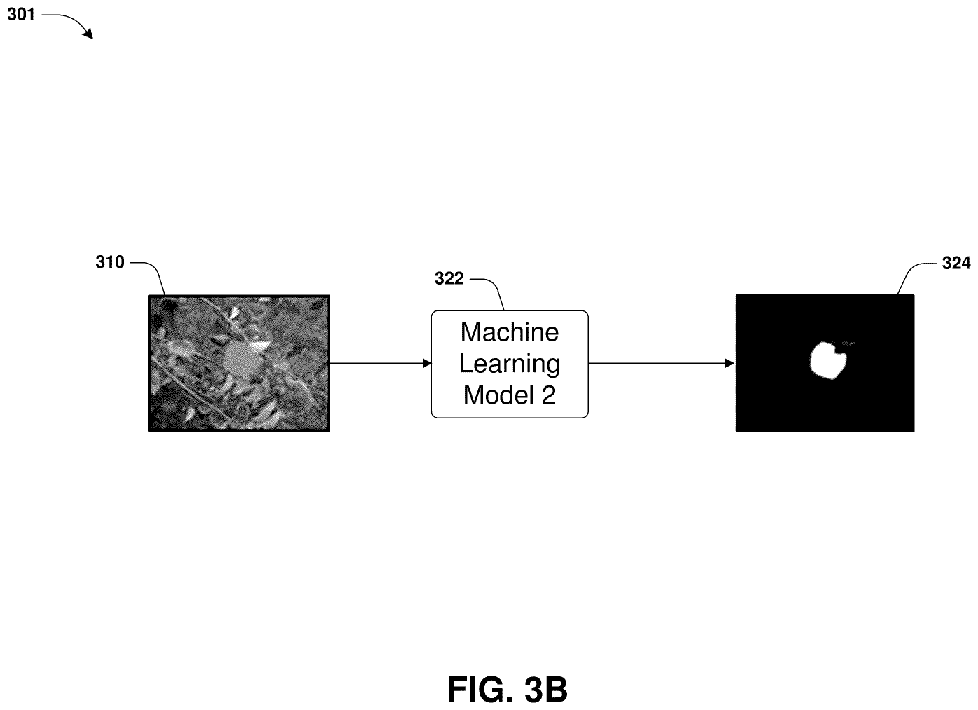

FIGS. 3A-3B illustrate examples of a system 301 for training the first machine learning model 164. In FIG. 3A, a region of an original image 302 may be masked to generate a second masked image 304 with a second masked region 306. The second masked region 306 may correspond to a second object (e.g., an apple) in the original image 302 (e.g., the second object in the original image 302 may be masked to generate the second masked image 304). For example, some or all pixels of the second object in the original image 302 may be set to a predefined color (e.g., a predefined pixel value), such as at least one of white, black, etc., to generate the second masked image 304. Alternatively and/or additionally, pixels of the original image 302 may be masked randomly and/or according to one or more predefined rules. In an example, a predefined proportion of the original image 302 (e.g., the predefined proportion may be between 15% of the original image 302 and 25% of the original image 302) may be masked to generate the second masked image 304.

In some examples, the first machine learning model 164 may replace the second masked region 306 of the second masked image 304 with a representation 312 of the second object to generate an output image 310. For example, the first machine learning model 164 may be used to regenerate pixels of the second masked region 306 of the second masked image 304 to generate the representation 312 of the second object (e.g., the apple). In some examples, the output image 310 may be generated (using the first machine learning model 164) based upon an object reference image 308 associated with the second object (e.g., the object reference image 308 may correspond to a reference image of the second object). For example, the output image 310 may be input to the first machine learning model 164.

In some examples, using the original image 302 and/or the object reference image 308, the first machine learning model 164 learns first contextual awareness information associated with a context of a pixel given its surroundings. For example, for each pixel of one, some and/or all pixels of the original image 302 and/or the object reference image 308, the first contextual awareness information may comprise a relationship of the pixel to the pixel's surroundings (e.g., the pixel's surroundings may correspond to pixels neighboring the pixel, such as pixels within a threshold distance of the pixel). In an example, the first contextual awareness information may comprise a relationship (e.g., a contextual relationship) between a color of the pixel and one or more colors of the pixel's surroundings, wherein the relationship may be determined by the first machine learning model 164 based upon a pixel value (e.g., a magnitude of the pixel value) of the pixel and/or one or more pixel values (e.g., magnitudes of the one or more pixel values) of the pixel's surroundings. Alternatively and/or additionally, the first contextual awareness information may comprise shapes and/or edges of objects and/or areas, which the first machine learning model 164 may learn based upon a gradient of a pixel change between the pixel and the pixel's surroundings. The first machine learning model 164 may be used to predict, based upon the first contextual awareness information, pixel values (e.g., indicative of pixel colors) of pixels of the second masked region 306 of the second masked image 304 to generate the representation 312 of the second object (e.g., the apple). For example, the representation 312 may be generated according to the predicted pixel values.

In some examples, the first loss function of the first machine learning model 164 may be used to determine a first difference between (i) a pixel value of a pixel in the original image 302 and (ii) a pixel value of a corresponding pixel in the output image 310 (e.g., the pixel value may correspond to a predicted pixel value predicted using the first machine learning model 164). In some examples, the first machine learning model 164 may be updated based upon the first difference and/or the first loss function. In an example, one or more weights and/or parameters of the first machine learning model 164 may be modified based upon the first difference. In an example, the first loss function may be used to determine one or more differences (e.g., a plurality of differences, each corresponding to a difference between an original pixel value of the original image 302 and a corresponding predicted pixel value of the output image 310) comprising the first difference, and a first loss value may be determined based upon the one or more differences. The one or more weights and/or parameters of the first machine learning model 164 may be modified based upon the first loss value. In some examples, the first machine learning model 164 comprises a first neural network model. In some examples, the first contextual awareness information (learned by the first machine learning model 164, for example), the first difference and/or the first loss value may be propagated (according to the first loss function, for example) across at least some of the first neural network model.

In some examples, the first machine learning model 164 is trained using a second machine learning model. In some examples, the second machine learning model is used to determine a context score associated with the output image 310, and the first machine learning model 164 may be trained based upon the context score.

In FIG. 3B, the second machine learning model (shown with reference number 322) is used to generate a fault flag representation 324 based upon the output image 310 (output by the first machine learning model 164). In an example, the second machine learning model 322 is used to classify each pixel of one, some and/or all pixels of the output image 310 as (i) an original pixel (e.g., a pixel from the original image 302) or (ii) a generated pixel (e.g., a pixel generated using the first machine learning model 164). For example, a pixel of the output image 310 may be classified as an original pixel based upon a determination (e.g., a determination by the second machine learning model 322) that the pixel is contextually related to the pixel's surroundings (e.g., a determination that the pixel is contextually suitable given the pixel's surroundings), wherein the pixel's surroundings may correspond to pixels neighboring the pixel, such as pixels within a threshold distance of the pixel. Alternatively and/or additionally, a pixel of the output image 310 may be classified as a generated pixel based upon a determination (e.g., a determination by the second machine learning model 322) that the pixel is not contextually related to the pixel's surroundings (e.g., a determination that the pixel is not contextually suitable given the pixel's surroundings).

In some examples, the fault flag representation 324 may be generated based upon a plurality of classifications (e.g., original pixel classifications and/or generated pixel classifications), of pixels in the output image 310, determined using the second machine learning model 322. For example, to generate the fault flag representation 324, pixels of the output image 310 that are classified as original pixels may be set to a first color (e.g., black) and pixels of the output image 310 that are classified as generated pixels may be set to a second color (e.g., white). In some examples, the context score may be determined based upon the plurality of classifications (and/or the fault flag representation 324) determined using the second machine learning model 322. In an example, the context score may be a function of (i) a first quantity of pixels, of the output image 310, that are classified as original pixels (e.g., the first quantity of pixels may equal a quantity of pixels, in the fault flag representation 324, that are set to black) and/or (ii) a second quantity of pixels, of the output image 310, that are classified as generated pixels (e.g., the second quantity of pixels may equal a quantity of pixels, in the fault flag representation 324, that are set to white), wherein an increase of the first quantity of pixels and/or a decrease of the second quantity of pixels may correspond to an increase of the context score. In an example, one or more operations (e.g., mathematical operations) may be performed using the first quantity of pixels and/or the second quantity of pixels to determine the context score.

In some examples, using the output image 310, the second machine learning model 322 learns second contextual awareness information associated with a context of a pixel given its surroundings. For example, for each pixel of one, some and/or all pixels of the output image 310, the second contextual awareness information may comprise a relationship of the pixel to the pixel's surroundings (e.g., the pixel's surroundings may correspond to pixels neighboring the pixel, such as pixels within a threshold distance of the pixel). In an example, the second contextual awareness information may comprise a relationship (e.g., a contextual relationship) between a color of the pixel and colors of the pixel's surroundings. The relationship may be determined by the second machine learning model 322 based upon a pixel value (e.g., a magnitude of the pixel value) of the pixel and/or one or more pixel values (e.g., magnitudes of the one or more pixel values) of the pixel's surroundings. Alternatively and/or additionally, the second contextual awareness information may comprise shapes and/or edges of objects and/or areas, which the second machine learning model 322 may learn based upon a gradient of a pixel change between the pixel and the pixel's surroundings. The second machine learning model 322 may be used to determine the context score, the plurality of classifications and/or the fault flag representation 324 based upon the second contextual awareness information.

In some examples, a second loss function of the second machine learning model 322 may be used to determine a second loss value. The second loss value may be based upon a difference between (i) actual generated pixels of the output image 310 (e.g., the actual generated pixels may correspond to pixels, of the output image 310, that were generated using the first machine learning model 164 and/or were not a part of the original image 302) and (ii) pixels, of the output image 310, that are classified as generated pixels by the second machine learning model 322. In some examples, the second machine learning model 322 may be updated based upon the second loss value (and/or the second loss function). In an example, one or more weights and/or parameters of the second machine learning model 322 may be modified based upon the second loss value (and/or the second loss function). In some examples, the second machine learning model 322 comprises a second neural network model. In some examples, the second contextual awareness information (learned by the second machine learning model 322, for example) and/or the second loss value may be propagated (according to the second loss function, for example) across at least some of the second neural network model. In some examples, the second loss function of the second machine learning model 322 may be connected to a generator mask of the second machine learning model 322.

In some examples, the first machine learning model 164 may be trained based upon the context score (and/or based upon the plurality of classifications) determined using the second machine learning model 322. In an example, one or more weights and/or parameters of the first machine learning model 164 may be modified based upon the context score (and/or based upon the plurality of classifications).

In some examples, acts shown in and/or discussed with respect to FIGS. 3A-3B may relate to a (single) training iteration for training the first machine learning model 164. In some examples, multiple training iterations may be performed to train the first machine learning model 164. For example, the multiple training iterations may be performed using different images (e.g., including images different than the original image 302) and/or different objects (e.g., including objects different than the second object). In some examples, each iteration of the multiple training iterations may be performed using one or more of the techniques shown in and/or discussed with respect to FIGS. 3A-3B. In some examples, training iterations may be performed on the first machine learning model 164 periodically, and/or upon receiving (new) training information. Alternatively and/or additionally, training iterations may cease being performed on the first machine learning model 164 in response to determining that the first machine learning model 164 is sufficiently trained. In an example, the determination that the first machine learning model 164 is sufficiently trained may be based upon (i) a determination that a loss value (e.g., the first loss value) associated with an original image (e.g., the original image 302) and/or an output image (e.g., the output image 310) generated by the first machine learning model 164 in a training iteration does not meet (e.g., is smaller than) a threshold loss value, and/or (ii) a determination that a context score (determined by the second machine learning model 322) of an output image (e.g., the output image 310) generated by the first machine learning model 164 meets (e.g., exceeds) a threshold context score.

It may be appreciated that training the first machine learning model 164 using the techniques provided herein may result in the first machine learning model 164 learning to regenerate masked pixels (e.g., generate pixels of the undistorted representation 168 of the first object) in a contextually aware manner (e.g., the first machine learning model 164 learns to identify contextual awareness of a pixel to the pixel's surroundings), thereby enabling the first machine learning model 164 to generate undistorted representations of distorted objects (e.g., the undistorted representation 168 of the first object) with increased accuracy. In an example, using the first masked image 162 and/or the distorted representation 160 of the first object, the first machine learning model 164 may learn third contextual awareness information associated with a context of a pixel given its surroundings. For example, for each pixel of one, some and/or all pixels of the first masked image 162 and/or the distorted representation 160 of the first object, the third contextual awareness information may comprise a relationship of the pixel to the pixel's surroundings (e.g., the pixel's surroundings may correspond to pixels neighboring the pixel, such as pixels within a threshold distance of the pixel). In an example, the third contextual awareness information may comprise a relationship (e.g., a contextual relationship) between a color of the pixel and colors of the pixel's surroundings (e.g., the relationship may be determined based upon a pixel value of the pixel and/or one or more pixel values of the pixel's surroundings). Alternatively and/or additionally, the third contextual awareness information may comprise shapes and/or edges of objects and/or areas (which may be learned based upon a gradient of a pixel change between the pixel and the pixel's surroundings, for example). The first machine learning model 164 may be used to predict, based upon the third contextual awareness information, pixel values (e.g., indicative of pixel colors) of pixels of the masked region 170 of the first masked image 162 to generate the undistorted representation 168 of the first object (e.g., the keyboard 146). For example, the undistorted representation 168 may be generated according to the predicted pixel values.

Referring back to FIG. 1E, in some examples, the modified image 166 may be generated to include an undistorted representation of each object of one, some and/or all of the objects identified in the region of interest 134. For example, the modified image 166 may comprise a plurality of (corrected) representations comprising an undistorted representation of the desk plant 142, an undistorted representation of the phone 144, an undistorted representation of the mouse 148, an undistorted representation of the eye-glasses 150, and/or an undistorted representation of the mug 152. In some examples, each representation of the plurality of representations may be generated using one or more of the techniques provided herein with respect to generating the undistorted representation 168 of the first object (e.g., the keyboard 146).

Returning back to FIG. 2, at 212, the video stream correction system may generate a second video stream comprising the modified image 166. In an example, the modified image 166 may correspond to a video frame of the second video stream. In some examples, the second video stream may correspond to a corrected version of the first video stream 102. For example, each video frame of one, some and/or all video frames of the first video stream 102 may be modified to generate a corrected video frame (using one or more of the techniques provided herein with respect to generating the modified image 166, for example), and the corrected video frame may be included in the second video stream. For example, corrected video frames, such as the modified image 166, may be compiled by the video stream correction system to generate the second video stream. The second video stream may be displayed on the second client device (during the video call, for example). In an example, the second video stream may be displayed on the second client device in response to establishing the video call. In some examples, the second video stream may comprise a desktop view (e.g., a view of the desktop of the desk 110) with undistorted (e.g., corrected) representations of one or more objects on the desktop of the desk 110 (e.g., at least one of the desk plant 142, the phone 144, the keyboard 146, the mouse 148, the eye-glasses 150, the mug 152, etc.). In this way, the user of the second client device may be able to view the desktop of the desk 110 (while conversing with the user 108 over the video call, for example).

In accordance with some embodiments, a machine learning model provided herein (e.g., at least one of the region of interest determination model 122, the first machine learning model 164, the second machine learning model 322, etc.) may comprise at least one of a tree-based model, a machine learning model used to perform linear regression, a machine learning model used to perform logistic regression, a decision tree model, a support vector machine (SVM), a Bayesian network model, a k-Nearest Neighbors (kNN) model, a K-Means model, a random forest model, a machine learning model used to perform dimensional reduction, a machine learning model used to perform gradient boosting, a neural network model (e.g., a deep neural network model and/or a convolutional neural network model), etc.

In accordance with some embodiments, at least some of the present disclosure may be performed and/or implemented automatically and/or in real time. For example, at least some of the present disclosure may be performed and/or implemented such that in response to receiving the first video frame 120 of the first video stream 102, the modified image 166 (e.g., which may be a corrected version of the first video frame 120) is output by the video stream correction system and/or is displayed on the second client device quickly (e.g., instantly) and/or in real time.

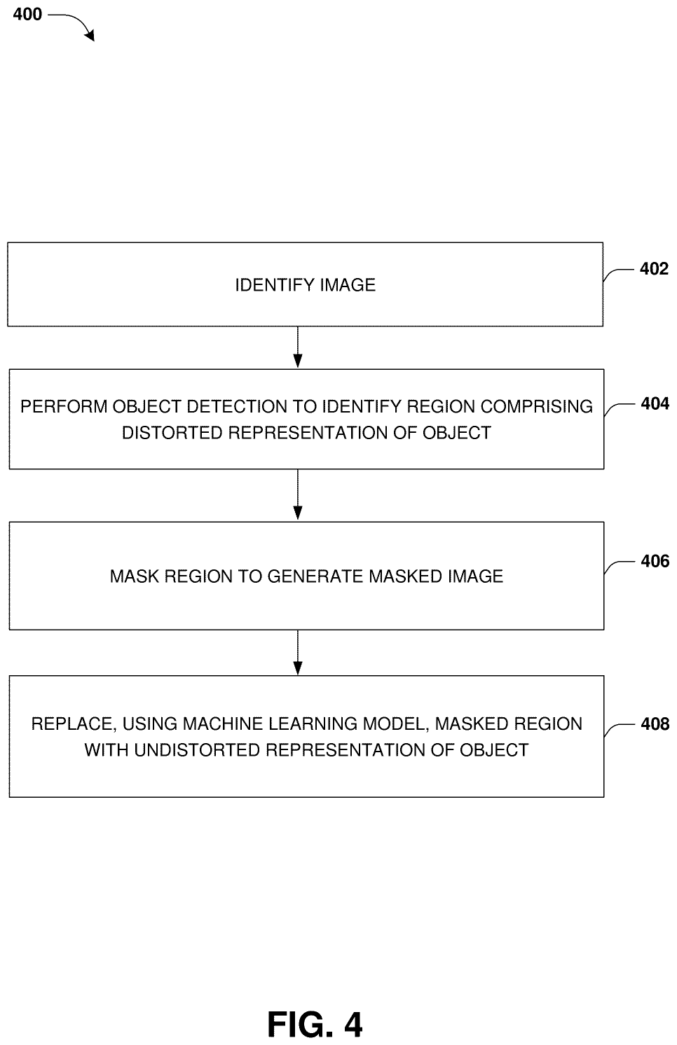

It may be appreciated that the techniques provided herein may be used for correcting distortions in an image (e.g., at least one of a single frame, a photograph, a graphical object, etc.). An embodiment of correcting distortions in an image is illustrated by an exemplary method 400 of FIG. 4. At 402, an image may be identified. At 404, object detection may be performed on the image to identify a region comprising a distorted representation of an object (e.g., a desk plant, a phone, a keyboard, a mouse, eye-glasses, a mug, or other object). At 406, the region may be masked to generate a masked image (e.g., the first masked image 162) comprising a masked region (e.g., the masked region 170) corresponding to the object. At 408, the masked region may be replaced, using a machine learning model (e.g., the first machine learning model 164), with an undistorted representation of the object to generate a modified (e.g., corrected) image. The modified image may be displayed on a client device.

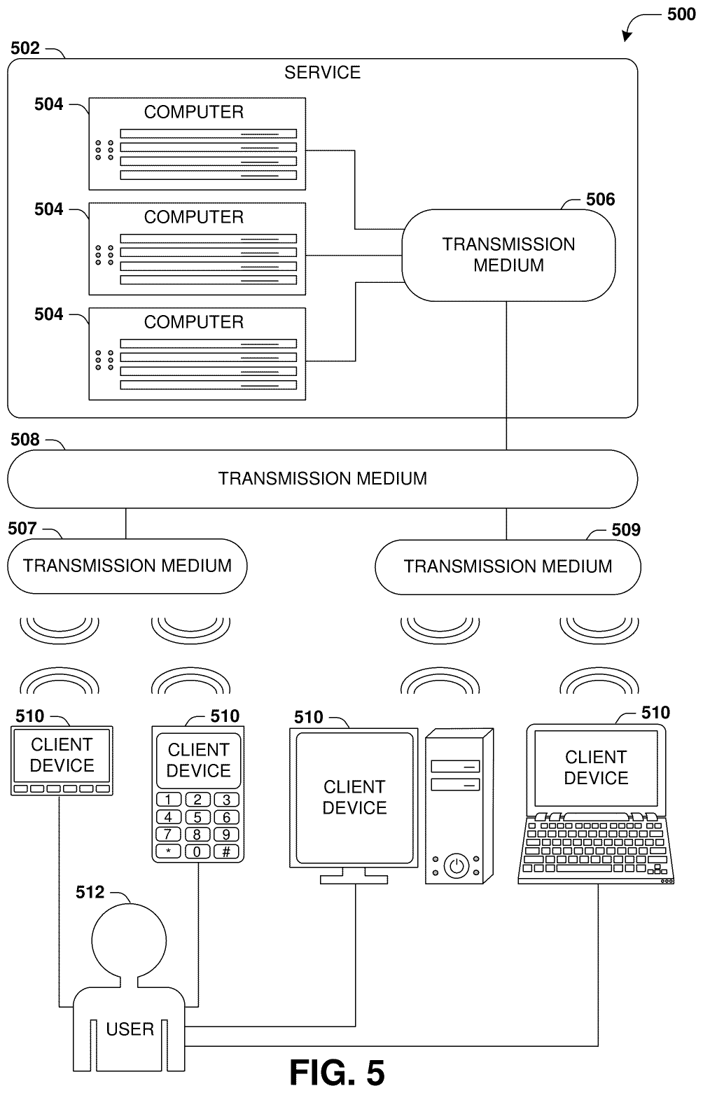

FIG. 5 is an interaction diagram of a scenario 500 illustrating a service 502 provided by a set of computers 504 to a set of client devices 510 (e.g., UEs) via various types of transmission mediums. The computers 504 and/or client devices 510 may be capable of transmitting, receiving, processing, and/or storing many types of signals, such as in memory as physical memory states.

The computers 504 of the service 502 may be communicatively coupled together, such as for exchange of communications using a transmission medium 506. The transmission medium 506 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 502.

Likewise, the transmission medium 506 may comprise one or more sub-networks, such as may employ different architectures, may be compliant or compatible with differing protocols and/or may interoperate within the transmission medium 506. Additionally, various types of transmission medium 506 may be interconnected (e.g., a router may provide a link between otherwise separate and independent transmission medium 506).

In scenario 500 of FIG. 5, the transmission medium 506 of the service 502 is connected to a transmission medium 508 that allows the service 502 to exchange data with other services 502 and/or client devices 510. The transmission medium 508 may encompass various combinations of devices with varying levels of distribution and exposure, such as a public wide-area network and/or a private network (e.g., a virtual private network (VPN) of a distributed enterprise).

In the scenario 500 of FIG. 5, the service 502 may be accessed via the transmission medium 508 by a user 512 of one or more client devices 510, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 510 may communicate with the service 502 via various communicative couplings to the transmission medium 508. As a first such example, one or more client devices 510 may comprise a cellular communicator and may communicate with the service 502 by connecting to the transmission medium 508 via a transmission medium 507 provided by a cellular provider. As a second such example, one or more client devices 510 may communicate with the service 502 by connecting to the transmission medium 508 via a transmission medium 509 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the computers 504 and the client devices 510 may communicate over various types of transmission mediums.

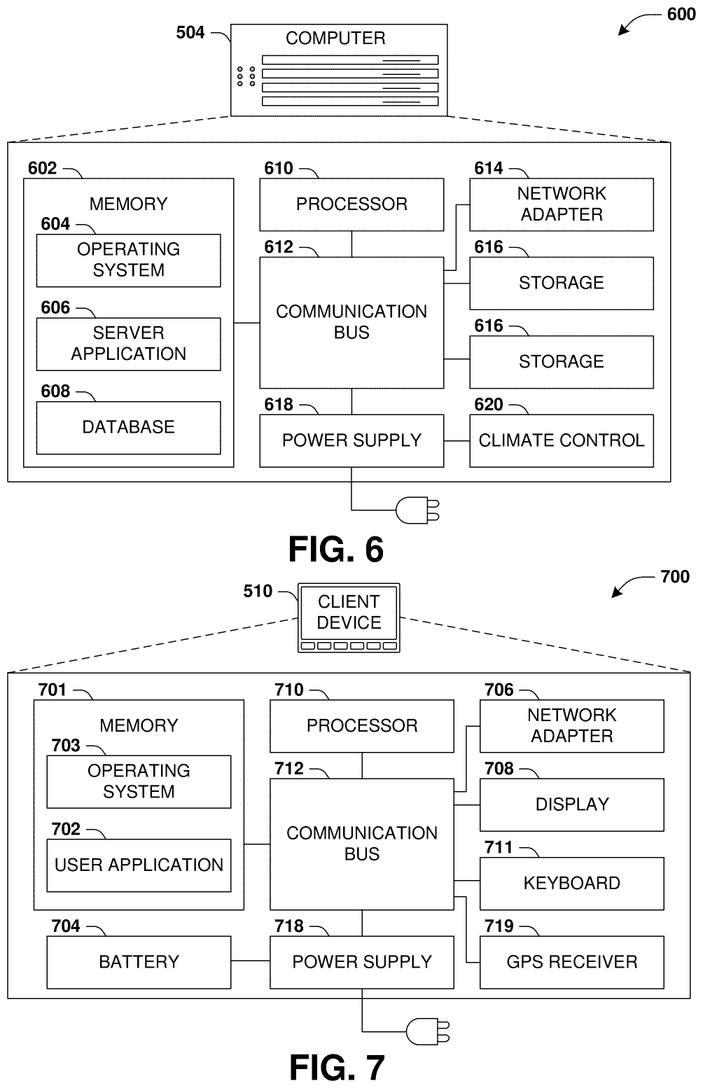

FIG. 6 presents a schematic architecture diagram 600 of a computer 504 that may utilize at least a portion of the techniques provided herein. Such a computer 504 may vary widely in configuration or capabilities, alone or in conjunction with other computers, in order to provide a service such as the service 502.

The computer 504 may comprise one or more processors 610 that process instructions. The one or more processors 610 may optionally include a plurality of cores; one or more coprocessors, such as a mathematics coprocessor or an integrated graphical processing unit (GPU); and/or one or more layers of local cache memory. The computer 504 may comprise memory 602 storing various forms of applications, such as an operating system 604; one or more computer applications 606; and/or various forms of data, such as a database 608 or a file system. The computer 504 may comprise a variety of peripheral components, such as a wired and/or wireless network adapter 614 connectible to a local area network and/or wide area network; one or more storage components 616, such as a hard disk drive, a solid-state storage device (SSD), a flash memory device, and/or a magnetic and/or optical disk reader.

The computer 504 may comprise a mainboard featuring one or more communication buses 612 that interconnect the processor 610, the memory 602, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 612 may interconnect the computer 504 with at least one other computer. Other components that may optionally be included with the computer 504 (though not shown in the schematic architecture diagram 600 of FIG. 6) include a display; a display adapter, such as a graphical processing unit (GPU); input peripherals, such as a keyboard and/or mouse; and a flash memory device that may store a basic input/output system (BIOS) routine that facilitates booting the computer 504 to a state of readiness.

The computer 504 may operate in various physical enclosures, such as a desktop or tower, and/or may be integrated with a display as an “all-in-one” device. The computer 504 may be mounted horizontally and/or in a cabinet or rack, and/or may simply comprise an interconnected set of components. The computer 504 may comprise a dedicated and/or shared power supply 618 that supplies and/or regulates power for the other components. The computer 504 may provide power to and/or receive power from another computer and/or other devices. The computer 504 may comprise a shared and/or dedicated climate control unit 620 that regulates climate properties, such as temperature, humidity, and/or airflow. Many such computers 504 may be configured and/or adapted to utilize at least a portion of the techniques presented herein.

FIG. 7 presents a schematic architecture diagram 700 of a client device 510 whereupon at least a portion of the techniques presented herein may be implemented. Such a client device 510 may vary widely in configuration or capabilities, in order to provide a variety of functionality to a user such as the user 512. The client device 510 may be provided in a variety of form factors, such as a desktop or tower workstation; an “all-in-one” device integrated with a display 708; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 510 may serve the user in a variety of roles, such as a workstation, kiosk, media player, gaming device, and/or appliance.

The client device 510 may comprise one or more processors 710 that process instructions. The one or more processors 710 may optionally include a plurality of cores; one or more coprocessors, such as a mathematics coprocessor or an integrated graphical processing unit (GPU); and/or one or more layers of local cache memory. The client device 510 may comprise memory 701 storing various forms of applications, such as an operating system 703; one or more user applications 702, such as document applications, media applications, file and/or data access applications, communication applications such as web browsers and/or email clients, utilities, and/or games; and/or drivers for various peripherals. The client device 510 may comprise a variety of peripheral components, such as a wired and/or wireless network adapter 706 connectible to a local area network and/or wide area network; one or more output components, such as a display 708 coupled with a display adapter (optionally including a graphical processing unit (GPU)), a sound adapter coupled with a speaker, and/or a printer; input devices for receiving input from the user, such as a keyboard 711, a mouse, a microphone, a camera, and/or a touch-sensitive component of the display 708; and/or environmental sensors, such as a global positioning system (GPS) receiver 719 that detects the location, velocity, and/or acceleration of the client device 510, a compass, accelerometer, and/or gyroscope that detects a physical orientation of the client device 510. Other components that may optionally be included with the client device 510 (though not shown in the schematic architecture diagram 700 of FIG. 7) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 510 to a state of readiness; and a climate control unit that regulates climate properties, such as temperature, humidity, and airflow.

The client device 510 may comprise a mainboard featuring one or more communication buses 712 that interconnect the processor 710, the memory 701, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 510 may comprise a dedicated and/or shared power supply 718 that supplies and/or regulates power for other components, and/or a battery 704 that stores power for use while the client device 510 is not connected to a power source via the power supply 718. The client device 510 may provide power to and/or receive power from other client devices.

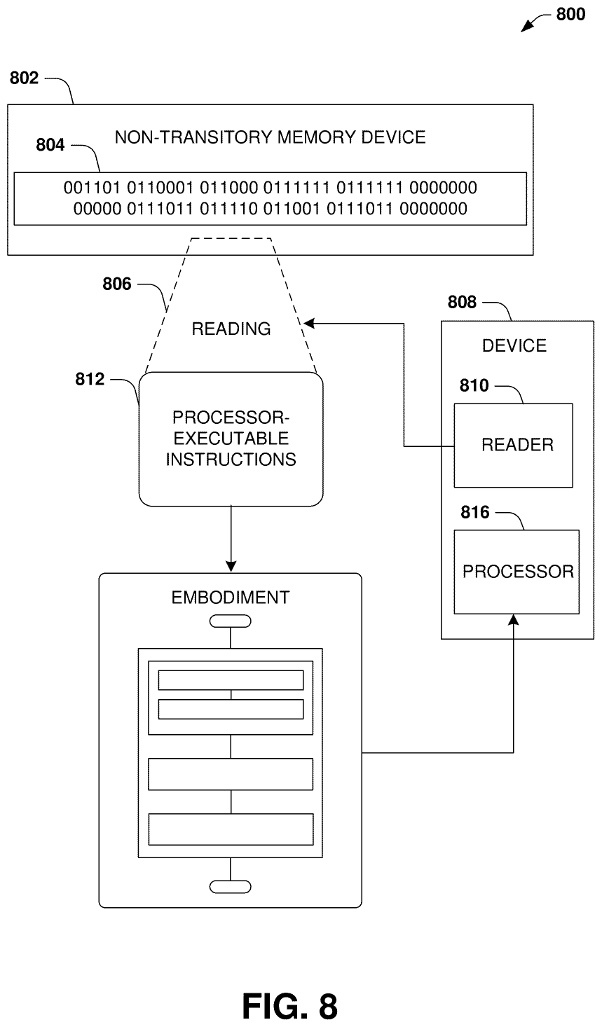

FIG. 8 is an illustration of a scenario 800 involving an example non-transitory machine-readable medium 802. The non-transitory machine-readable medium 802 may comprise processor-executable instructions 812 that when executed by a processor 816 cause performance (e.g., by the processor 816) of at least some of the provisions herein. The non-transitory machine-readable medium 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 802 stores computer-readable data 804 that, when subjected to reading 806 by a reader 810 of a device 808 (e.g., a read head of a hard disk drive, or a read operation invoked on a solid-state storage device), express the processor-executable instructions 812. In some embodiments, the processor-executable instructions 812, when executed cause performance of operations, such as at least some of the example method 200 of FIG. 2 and/or at least some of the example method 400 of FIG. 4, for example. In some embodiments, the processor-executable instructions 812 are configured to cause implementation of a system, such as at least some of the example system 101 of FIGS. 1A-1E and/or at least some of the example system 301 of FIGS. 3A-3B, for example.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed is:

1. A method, comprising:
receiving a first video stream;
analyzing a video frame of the first video stream to identify a region of interest of the video frame;
performing object detection on the region of interest to identify a region comprising a distorted representation of an object;
masking the region to generate a masked image comprising a masked region corresponding to the object;
replacing, using a machine learning model, the masked region with an undistorted representation of the object to generate a modified image; and
generating a second video stream comprising the modified image.

2. The method of claim 1, wherein:
replacing the masked region with the undistorted representation of the object is performed based upon the distorted representation of the object.

3. The method of claim 1, wherein:
the machine learning model comprises a neural network model.

4. The method of claim 1, comprising:
training the machine learning model using a second machine learning model.

5. The method of claim 4, wherein training the machine learning model comprises:
replacing, using the machine learning model and an object reference image associated with a second object, a second masked region of a second masked image with a representation of the second object to generate an image;
determining, using the second machine learning model, a context score associated with the image; and
training the machine learning model based upon the context score.

6. The method of claim 1, wherein:
the region of interest comprises a representation of a desktop of a desk; and
the object corresponds to an item on the desktop.

7. The method of claim 1, comprising:
displaying the second video stream on a client device.

8. The method of claim 7, comprising:
establishing a video call between the client device and a second client device, wherein:
the first video stream is captured using a camera associated with the second client device; and
displaying the second video stream on the client device is performed in response to establishing the video call.

9. A non-transitory computer-readable medium storing instructions that when executed perform operations comprising:
identifying an image;
performing object detection on the image to identify a region comprising a distorted representation of an object;
masking the region to generate a masked image comprising a masked region corresponding to the object; and
replacing, using a machine learning model, the masked region with an undistorted representation of the object to generate a modified image.

10. The non-transitory computer-readable medium of claim 9, wherein:
replacing the masked region with the undistorted representation of the object is performed based upon the distorted representation of the object.

11. The non-transitory computer-readable medium of claim 9, wherein:
the machine learning model comprises a neural network model.

12. The non-transitory computer-readable medium of claim 9, the operations comprising:
training the machine learning model using a second machine learning model.

13. The non-transitory computer-readable medium of claim 12, wherein training the machine learning model comprises:
replacing, using the machine learning model and an object reference image associated with a second object, a second masked region of a second masked image with a representation of the second object to generate a second image;
determining, using the second machine learning model, a context score associated with the second image; and
training the machine learning model based upon the context score.

14. The non-transitory computer-readable medium of claim 9, the operations comprising:
analyzing the image to identify a region of interest of the image, wherein the object detection is performed on the region of interest.

15. The non-transitory computer-readable medium of claim 14, wherein:
the region of interest comprises a representation of a desktop of a desk; and
the object corresponds to an item on the desktop.

16. A device comprising:
a processor configured to execute instructions to perform operations comprising:
identifying an image;
performing object detection on the image to identify a region comprising a distorted representation of an object;
masking the region to generate a masked image comprising a masked region corresponding to the object; and
replacing, using a machine learning model, the masked region with an undistorted representation of the object to generate a modified image.

17. The device of claim 16, wherein:
replacing the masked region with the undistorted representation of the object is performed based upon the distorted representation of the object.

18. The device of claim 16, wherein:
the machine learning model comprises a neural network model.

19. The device of claim 16, the operations comprising:
training the machine learning model using a second machine learning model.

20. The device of claim 19, wherein training the machine learning model comprises:
replacing, using the machine learning model and an object reference image associated with a second object, a second masked region of a second masked image with a representation of the second object to generate a second image;
determining, using the second machine learning model, a context score associated with the second image; and
training the machine learning model based upon the context score.
